(19) United States
(12) Patent Application Publication
(10) Pub. No.: US 2025/0274826 A1
(43) Pub. Date: Aug. 28, 2025

(54) MOBILITY ENHANCEMENTS UNDER COVERAGE AND CAPACITY OPTIMIZATION

(71) Applicant: QUALCOMM Incorporated, San Diego, CA (US)

(72) Inventors: Hung Dinh LY, San Diego, CA (US); Kexin XIAO, Shanghai (CN); Wanshi CHEN, San Diego, CA (US)

(21) Appl. No.: 18/859,045

(22) PCT Filed: Jul. 8, 2022
(86) PCT No.: PCT/CN2022/104545

§ 371 Date: Oct. 22, 2024

(51) Int. Cl. H04W 36/00

(52) U.S. Cl. CPC H04W 36/0094; H04W 36/00837

(57) ABSTRACT

Various aspects of the present disclosure generally relate to wireless communication. In some aspects, a user equipment (UE) may receive configuration information indicating a plurality of configurations, the plurality of configurations indicating at least one of: a plurality of values for a measurement reporting event, or a plurality of scaling factors for a metric associated with the measurement reporting event. The UE may receive an indication of a selected configuration of the plurality of configurations. The UE may measure a reference signal based at least in part on the selected configuration. Numerous other aspects are described.

### FIELD OF THE DISCLOSURE

Aspects of the present disclosure generally relate to wireless communication and to techniques and apparatuses for mobility enhancements under coverage and capacity optimization.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a WiFi link, or a Bluetooth link).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving configuration information indicating a plurality of configurations, the plurality of configurations indicating at least one of a plurality of values for a measurement reporting event, or a plurality of scaling factors for a metric associated with the measurement reporting event. The method may include receiving an indication of a selected configuration of the plurality of configurations. The method may include measuring a reference signal based at least in part on the selected configuration.

Some aspects described herein relate to a method of wireless communication performed by a network node. The method may include transmitting configuration information indicating a plurality of configurations, the plurality of configurations indicating at least one of a plurality of values for a measurement reporting event, or a plurality of scaling factors for a metric associated with the measurement reporting event. The method may include transmitting, for a UE, an indication of a selected configuration of the plurality of configurations. The method may include receiving a measurement report associated with the UE based at least in part on the selected configuration.

Some aspects described herein relate to a UE for wireless communication. The user equipment may include a memory and one or more processors coupled to the memory. The one or more processors may be configured to receive configuration information indicating a plurality of configurations, the plurality of configurations indicating at least one of a plurality of values for a measurement reporting event, or a plurality of scaling factors for a metric associated with the measurement reporting event. The one or more processors may be configured to receive an indication of a selected configuration of the plurality of configurations. The one or more processors may be configured to measure a reference signal based at least in part on the selected configuration.

Some aspects described herein relate to a network node for wireless communication. The network node may include a memory and one or more processors coupled to the memory. The one or more processors may be configured to transmit configuration information indicating a plurality of configurations, the plurality of configurations indicating at least one of a plurality of values for a measurement reporting event, or a plurality of scaling factors for a metric associated with the measurement reporting event. The one or more processors may be configured to transmit, for a UE, an indication of a selected configuration of the plurality of configurations. The one or more processors may be configured to receive a measurement report associated with the UE based at least in part on the selected configuration.

Some aspects described herein relate to a non-transitory computer-readable medium that stores a set of instructions for wireless communication by a UE. The set of instructions, when executed by one or more processors of the UE, may cause the UE to receive configuration information indicating a plurality of configurations, the plurality of configurations indicating at least one of a plurality of values for a measurement reporting event, or a plurality of scaling factors for a metric associated with the measurement reporting event. The set of instructions, when executed by one or more processors of the UE, may cause the UE to receive an indication of a selected configuration of the plurality of configurations. The set of instructions, when executed by one or more processors of the UE, may cause the UE to measure a reference signal based at least in part on the selected configuration.

Some aspects described herein relate to a non-transitory computer-readable medium that stores a set of instructions for wireless communication by a network node. The set of instructions, when executed by one or more processors of the network node, may cause the network node to transmit configuration information indicating a plurality of configurations, the plurality of configurations indicating at least one of a plurality of values for a measurement reporting event, or a plurality of scaling factors for a metric associated with the measurement reporting event. The set of instructions, when executed by one or more processors of the network node, may cause the network node to transmit, for a UE, an indication of a selected configuration of the plurality of configurations. The set of instructions, when executed by one or more processors of the network node, may cause the network node to receive a measurement report associated with the UE based at least in part on the selected configuration.

Some aspects described herein relate to an apparatus for wireless communication. The apparatus may include means for receiving configuration information indicating a plurality of configurations, the plurality of configurations indicating at least one of, a plurality of values for a measurement reporting event, or a plurality of scaling factors for a metric associated with the measurement reporting event. The apparatus may include means for receiving an indication of a selected configuration of the plurality of configurations. The apparatus may include means for measuring a reference signal based at least in part on the selected configuration.

Some aspects described herein relate to an apparatus for wireless communication. The apparatus may include means for transmitting configuration information indicating a plurality of configurations, the plurality of configurations indicating at least one of, a plurality of values for a measurement reporting event, or a plurality of scaling factors for a metric associated with the measurement reporting event. The apparatus may include means for transmitting, for a UE, an indication of a selected configuration of the plurality of configurations. The apparatus may include means for receiving a measurement report associated with the UE based at least in part on the selected configuration.

Aspects generally include a method, apparatus, system, computer program product, non-transitory computer-readable medium, user equipment, base station, wireless communication device, network node, network entity, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a base station in communication with a user equipment (UE) in a wireless network, in accordance with the present disclosure.

FIG. 3 is a diagram illustrating an example of dynamic network-side antenna adaptation, in accordance with the present disclosure.

FIG. 4 is a diagram illustrating an example of signaling associated with measurement reporting event adjustment, in accordance with the present disclosure.

FIG. 5 is a diagram illustrating an example of signaling associated with adjustment of a metric associated with a measurement reporting event, in accordance with the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

FIG. 10 is a diagram illustrating an example disaggregated base station architecture, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

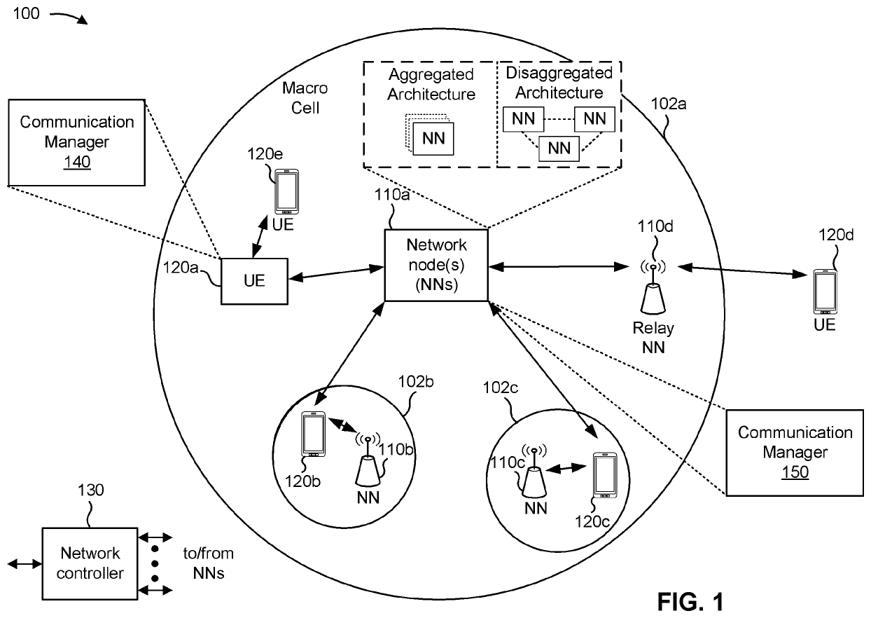

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing 284 that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V21) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive configuration information indicating a plurality of configurations, the plurality of configurations indicating at least one of: a plurality of values for a measurement reporting event, or a plurality of scaling factors for a metric associated with the measurement reporting event; receive an indication of a selected configuration of the plurality of configurations; and measure a reference signal based at least in part on the selected configuration. Additionally, or alternatively, the communication manager 140 may perform one or more other operations described herein.

In some aspects, the network node 110 may include a communication manager 150. As described in more detail elsewhere herein, the communication manager 150 may transmit configuration information indicating a plurality of configurations, the plurality of configurations indicating at least one of: a plurality of values for a measurement reporting event, or a plurality of scaling factors for a metric associated with the measurement reporting event; transmit, for a UE, an indication of a selected configuration of the plurality of configurations; and receive a measurement report associated with the UE based at least in part on the selected configuration. Additionally, or alternatively, the communication manager 150 may perform one or more other operations described herein.

As indicated above, FIG. 1 is provided as an example. Other examples may differ from what is described with regard to FIG. 1.

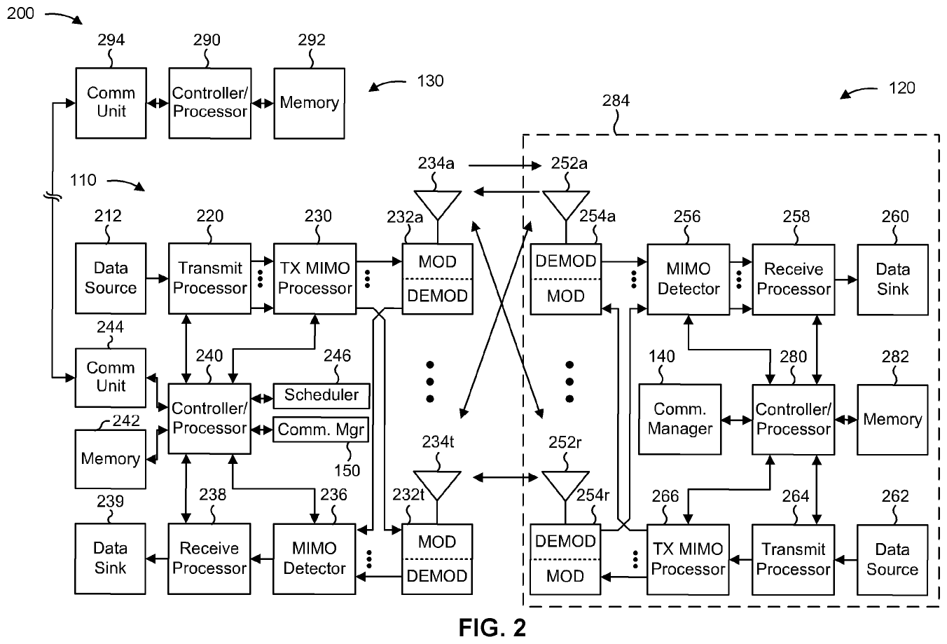

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein.

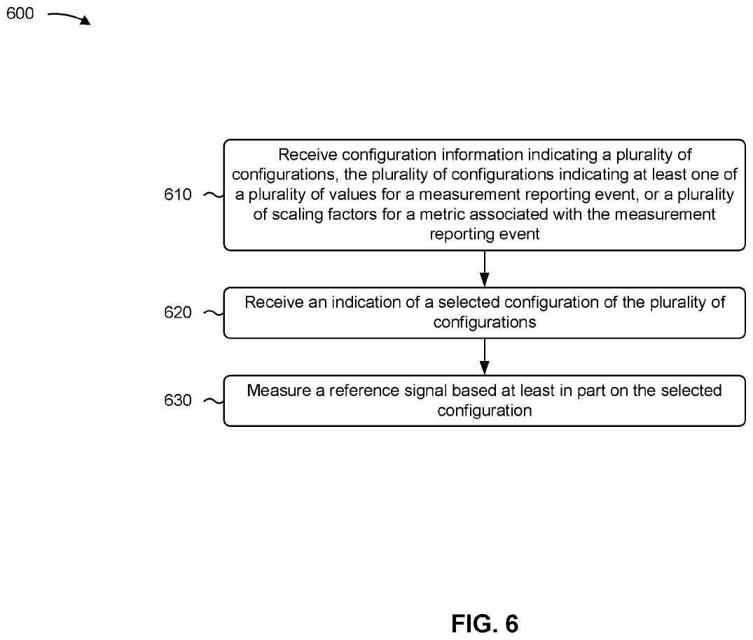

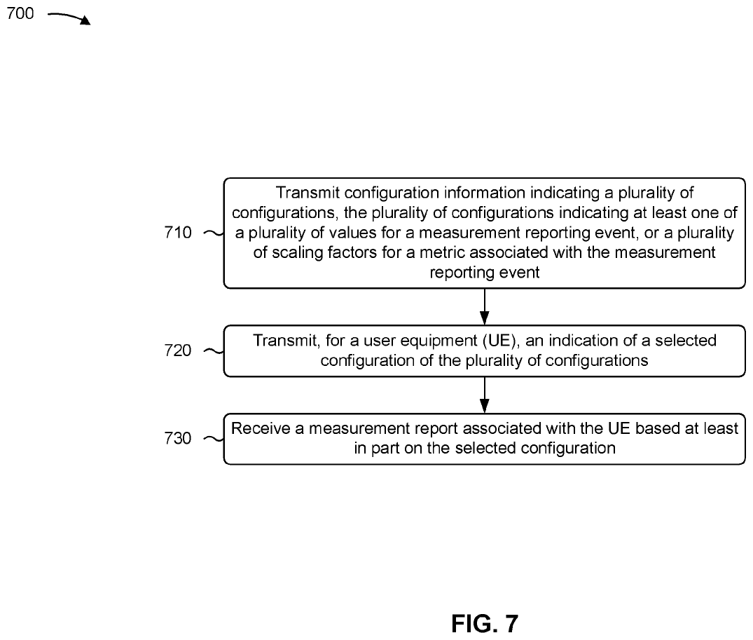

The controller/processor 240 of the network node 110, the controller/processor 280 of the UE 120, and/or any other component(s) of FIG. 2 may perform one or more techniques associated with mobility enhancements, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE 120 includes means for receiving configuration information indicating a plurality of configurations, the plurality of configurations indicating at least one of: a plurality of values for a measurement reporting event, or a plurality of scaling factors for a metric associated with the measurement reporting event; means for receiving an indication of a selected configuration of the plurality of configurations; and/or means for measuring a reference signal based at least in part on the selected configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for transmitting configuration information indicating a plurality of configurations, the plurality of configurations indicating at least one of: a plurality of values for a measurement reporting event, or a plurality of scaling factors for a metric associated with the measurement reporting event; means for transmitting, for a UE, an indication of a selected configuration of the plurality of configurations; and/or means for receiving a measurement report associated with the UE based at least in part on the selected configuration. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

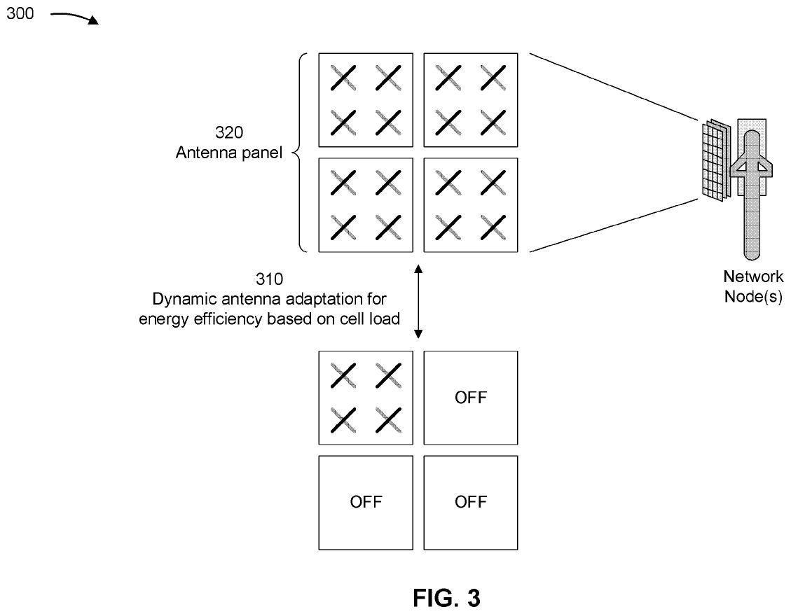

FIG. 3 is a diagram illustrating an example 300 of dynamic network-side antenna adaptation, in accordance with the present disclosure.

For various reasons, including climate change mitigation and network cost reduction, energy-saving and/or energy efficiency measures are expected to have increasing importance in wireless network operations. For example, although NR generally offers a significant energy-efficiency improvement per gigabyte over previous generations (e.g., LTE), new NR use cases and/or the adoption of millimeter wave frequencies require more network sites and more network antennas, which could potentially lead to a more efficient cellular network that nonetheless has higher energy requirements and/or causes more emissions than previous generations. Furthermore, energy accounts for a significant proportion of the cost to operate a cellular network. For example, according to some estimates, energy costs are nearly 23% of the total cost to operate a cellular network, with selling, general, and administrative (SG&A) expenses and other costs accounting for about 75%, and over 90% of network operating costs are spent on energy (e.g., fuel and electricity consumption). Most energy consumption and/or energy costs are associated with powering a RAN, which accounts for about 30% of the energy consumed by a wireless network, with data centers and fiber transport accounting for smaller shares. Accordingly, measures to increase energy savings and/or energy efficiency in a wireless network are important factors that may drive adoption and/or expansion of cellular networks.

One way to increase energy efficiency in a RAN may be to use dynamic network antenna adaptation in a base station that communicates using massive MIMO technology, which tends to consume significant power. For example, in an LTE network, a base station that supports massive MIMO technology may communicate using a baseband unit (BBU) that processes baseband signals and communicates with a core network through a physical interface and a remote radio unit (RRU) that performs transmit and receive radio frequency (RF) functions. In an LTE network, the per-cell power consumption (e.g., in watts) is slightly larger for the RRU compared to the BBU, and the per-cell power consumption does not vary significantly with cell load. In an NR network, however, a network node that supports massive MIMO technology may communicate using a BBU and an active antenna unit (AAU) that consumes significantly more power than the BBU and the RRU in an LTE base station (e.g., because NR operates at a higher data rate and/or a higher bandwidth than LTE). For example, the BBU and the AAU of an NR network node or group of network nodes may consume 2.4 times the power of the BBU and RRU in an LTE base station when the cell load is low (e.g., 0%), 2.6 times the power of the BBU and RRU in an LTE base station when the cell load is moderate (e.g., 30%), or 3 times the power of the BBU and RRU in an LTE base station when the cell load is high (e.g., 100%), where “cell load” generally refers to the proportion of frequency resources within a carrier that are being utilized at a given time. Furthermore, in an NR network node, the AAU generally consumes more power than the BBU, and the proportion of power consumption attributable to the AAU increases as the cell loading increases (e.g., because the BBU has a relatively static power consumption regardless of cell loading). Accordingly, in an NR base station that supports massive MIMO technology, the AAU represents the most power-hungry component.

Accordingly, as shown in FIG. 3, and by reference number 310, a network node that supports massive MIMO communication may enable dynamic network antenna adaptation based on a current and/or predicted cell load in order to improve energy efficiency. For example, to enable massive MIMO communication, a network node may generally need to have multiple co-located antenna panels that each include multiple antenna ports. For example, in FIG. 3, reference number 320 depicts an example antenna panel that includes four (4) sub-panels, each of which includes several antenna ports (shown as gray and black intersecting lines) that each map to one or more physical antennas, where each diagonal line in FIG. 3 corresponds to one (1) antenna port and a color of the diagonal line represents a polarization of the antenna port (e.g., horizontal or vertical). In general, each antenna panel is equipped with various power amplifiers and an antenna subsystem, which consume significant power. Accordingly, in order to save power or otherwise utilize energy more efficiently, the network node may dynamically adapt an antenna configuration based on a current and/or predicted cell load. For example, when the cell load is high, the network node may turn all (or most) antenna panels, sub-panels, and/or ports on to increase capacity, and the network node may turn off some antenna panels, sub-panels, and/or ports to reduce energy consumption when the cell load is low. In some examples, the network node may perform dynamic beam adaptation, in which one or more beams are turned off (such as based at least in part on load on the one or more beams) to reduce energy consumption.

However, in cases where the network node supports dynamic network antenna adaptation (e.g., to use energy more efficiently depending on cell load or other factors), the change in antenna configuration parameters may lead to changes in coverage of the network node. For example, dynamic network antenna adaptation or dynamic beam adaptation for network energy savings may incur a cell coverage loss due to the reduced transmit power and beamforming gain of the network node. Some networks may allow a cell to compensate the coverage loss of another cell (referred to as coverage and capacity optimization (CCO)). An updated antenna or beam configuration can be scheduled before actual traffic arrives using the updated antenna or beam configuration (e.g., based at least in part on UE feedback, such as predicted traffic and channel state information (CSI) reporting). In some cases, a coverage reduction at a serving cell may cause a UE to perform a handover to a neighbor cell after the serving cell has completed the coverage reduction. However, such a handover may introduce interruption, latency, and unreliability for communications of the UE. This may be particularly impactful for UEs with time-critical or data sensitive services (such as extended reality (XR), ultra-reliable communications, low-latency communications, or the like).

Some techniques and apparatuses described herein provide selection of a threshold for a measurement reporting event, and/or selection of a scaling factor to be applied for a metric associated with the measurement reporting event. The measurement reporting event may be associated with handover of the UE. The selection of the threshold or scaling factor may be from multiple configured thresholds or scaling factors, such as multiple configurations of the thresholds or scaling factors. In some examples, a network node may select the threshold or scaling factor based at least in part on a prediction of a change in coverage. For example, the network node may select a threshold or scaling factor that is likely to trigger an earlier handover when a decrease in coverage of the network node is predicted (such as due to a dynamic antenna or beam adaptation). In this way, interruption, latency, and unreliability of communications of the UE are reduced by triggering a handover before coverage of the network node is reduced due to the dynamic antenna or beam adaptation. Furthermore, these techniques (the selection of the threshold or scaling factor to trigger an earlier handover than another threshold or scaling factor) can be applied in situations where activity (e.g., cell load) of the network node is to be reduced, irrespective of whether the network node predicts a change in coverage.

As indicated above, FIG. 3 is provided as an example. Other examples may differ from what is described with regard to FIG. 3.

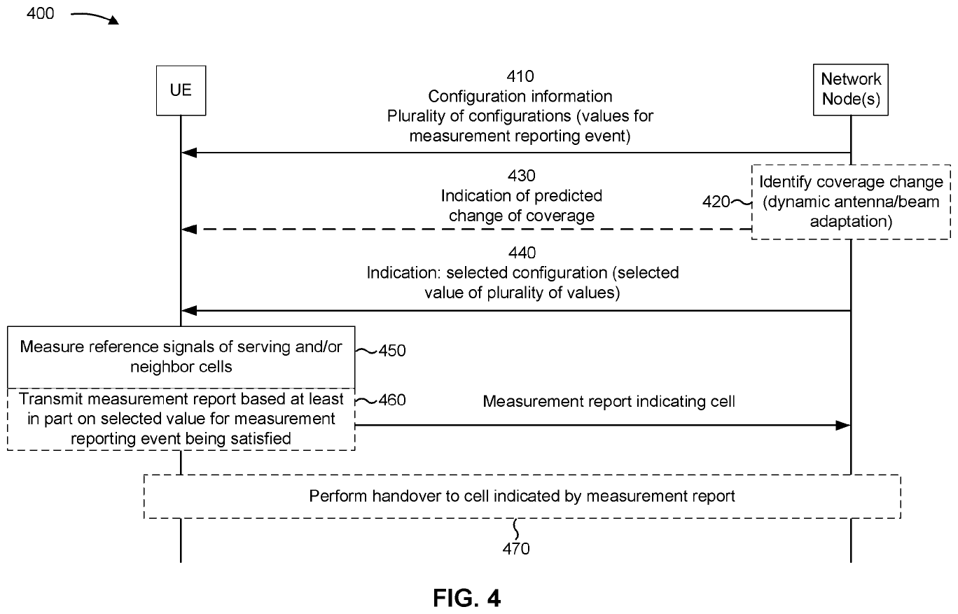

FIG. 4 is a diagram illustrating an example 400 of signaling associated with measurement reporting event adjustment, in accordance with the present disclosure. As shown, example 400 includes a UE (e.g., UE 120) and a network node (e.g., network node 110). The network node may provide a serving cell of the UE. A serving cell is a cell on which the UE has an active connection (e.g., a radio resource control (RRC) connection) with the network node. In some aspects, the network node may include multiple network nodes, such as a CU and a DU, a CU and an RU, a DU and an RU, or a different combination of network nodes.

As shown in FIG. 4, and by reference number 410, the network node (e.g., a CU and/or a DU) may transmit, and the UE may receive, configuration information. For example, the configuration information may be transmitted via control signaling, such as RRC signaling or the like. The configuration information may include a plurality of configurations. A configuration, of the plurality of configurations, may identify a value for a measurement reporting event. For example, the value may be a threshold for the measurement reporting event, such as a threshold value of a metric determined based at least in part on measuring a reference signal, or a threshold length of time based on which the measurement reporting event is triggered. Thus, the configuration information may include a plurality of values for a measurement reporting event.

In some aspects, the configuration information may include a measurement configuration, or multiple measurement configurations, that identify or include the plurality of configurations. The measurement configuration may identify configurations for one or more neighbor measurements to be performed by the UE 120. In some aspects, the one or more neighbor measurements may be associated with respective target carriers, cells, or frequencies. A neighbor measurement may include, for example, an RSRP measurement (e.g., a synchronization signal RSRP (SS-RSRP) measurement), an RSRQ measurement (e.g., a synchronization signal RSRQ (SS-RSRQ) measurement), a signal to interference and noise ratio (SINR) value (e.g., a synchronization signal SINR (SS-SINR) measurement), and/or the like.

A measurement configuration is a configuration provided from the network node to the UE to configure the UE to perform measurements, such as NR measurements, inter radio access technology measurements of Evolved Universal Mobile Telecommunications System (UMTS) Terrestrial Radio Access (E-UTRA) frequencies, or the like. The measurement configuration may configure the UE to report measurement information based at least in part on measurement resources such as synchronization signal blocks (SSBs), channel state information reference signal (CSI-RS) resources, channel state information interference management (CSI-IM) resources, or the like. The measurement configuration may include measurement objects, reporting configurations, measurement identities, quantity configurations, measurement gap configurations, or a combination thereof. A measurement object may provide a list of objects (e.g., frequency resources, time resources, and subcarrier spacings of reference signals) on which the UE may perform the measurements for intra-frequency and inter-frequency operations. A reporting configuration may indicate a reporting criterion (e.g., a value associated with a measurement reporting event), a reference signal type, and/or a reporting format for a measurement object. A measurement identity may link a measurement object with a reporting configuration. A quantity configuration may describe filter coefficients for Layer 3 filtering of the measurements. A measurement gap configuration may indicate a gap in which the UE 120 is to perform a measurement. In some aspects, the UE 120 may determine measurement information based at least in part on the one or more measurement configurations and/or may report the measurement information based at least in part on the one or more measurement configurations.

A measurement reporting event can include, for example, an A1 reporting event (e.g., a metric associated with a serving cell becomes better than a threshold), an A2 reporting event (e.g., a metric associated with a serving cell becomes worse than a threshold), an A3 reporting event (e.g., a metric associated with a neighbor cell becomes better than a special cell (SPCell) by a threshold), an A4 reporting event (e.g., a metric associated with a neighbor cell becomes better than a threshold), an A5 reporting event (e.g., a metric associated with a special cell is worse than a first threshold and a metric associated with a neighboring cell is better than a second threshold), an A6 reporting event (e.g., a metric associated with a neighbor cell becomes better than a metric associated with a secondary cell by a threshold), a B1 reporting event (e.g., a metric associated with a neighbor inter-system cell becomes better than a threshold), or a B2 reporting event (e.g., a metric associated with a primary serving cell is worse than a first threshold and a metric associated with a neighbor inter-system cell is better than a second threshold). A value associated with a measurement reporting event (also referred to herein as a reporting criterion) may indicate a threshold associated with a measurement reporting event (e.g., a time based threshold indicating a threshold length of time, or a threshold for a metric associated with the measurement reporting event), or a first threshold and/or a second threshold associated with the measurement reporting event, such as the thresholds described with regard to the reporting events above. The network node may configure a plurality of values associated with a measurement reporting event (or a respective plurality of values for each measurement reporting event of a plurality of measurement reporting events). For example, a single reporting configuration may include multiple reporting criteria, or a measurement configuration may include multiple reporting configurations.

In some aspects, the plurality of configurations may be common across multiple cells. For example, each neighbor cell of the UE may be associated with the same plurality of configurations, meaning that a value of a measurement reporting event is selected from the same plurality of values for any neighbor cell. In some aspects, a plurality of configurations may be cell-specific. For example, a first cell may be associated with a first plurality of configurations (from which a value for a threshold for a measurement reporting event of the first cell can be selected), and a second cell may be associated with a second plurality of configurations (from which a value for a threshold for a measurement reporting event of the second cell can be selected).

In some aspects, the plurality of configurations may be common across two or more types of measurement. For example, the same plurality of configurations may be applied for a threshold associated with an SINR metric, a threshold associated with an RSRP metric, and a threshold associated with an RSRQ metric. In some aspects, the plurality of configurations may be specific to a type of measurement. For example, a first plurality of configurations may be applied for a threshold associated with an SINR metric, and a second plurality of configurations may be applied for a threshold associated with an RSRP metric.

As shown by reference number 420, the network node (e.g., a CU, a DU, and/or an RU) may identify a coverage change. For example, the network node may identify a predicted coverage change of the serving cell associated with the network node. In some aspects, the network node may identify the predicted coverage change based at least in part on dynamic network antenna adaptation and/or dynamic beam adaptation. For example, the network node may identify that the network node will deactivate one or more antennas, antenna sub-panels, or antenna panels at a future time.

As another example, the network node may identify that the network node will deactivate one or more beams at a future time. Thus, the network node may identify a predicted coverage change that will be caused by the deactivation of the one or more beams, antennas, antenna sub-panels, or antenna panels.

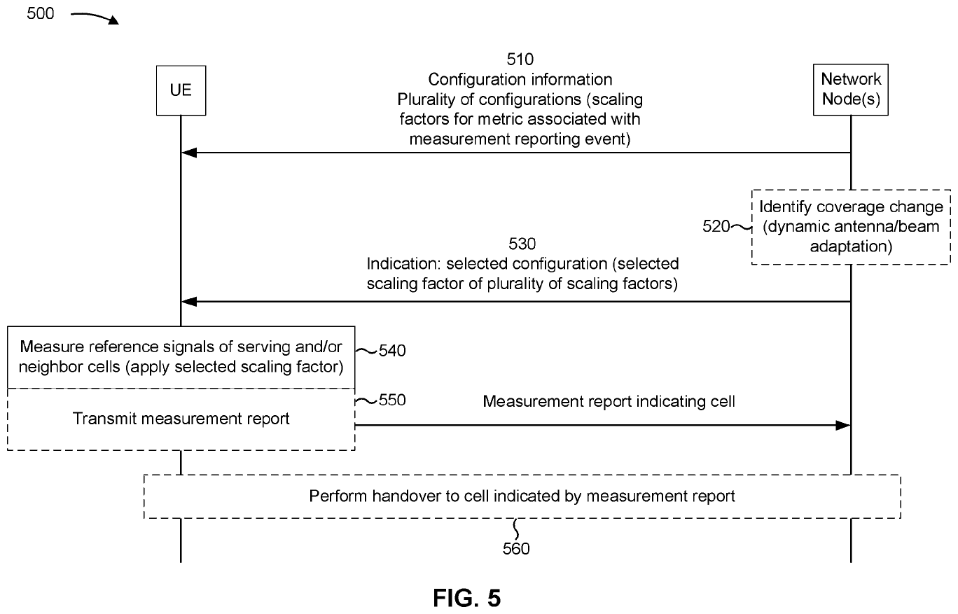

As shown by reference number 430, in some examples, the network node (e.g., a CU and/or a DU) may transmit, and the UE may receive, an indication of the predicted coverage change. For example, the serving cell associated with the network node may advertise an indicator that indicates a “next step” of the serving cell. In some aspects, the network node (e.g., a CU and/or DU) may provide the indication for transmission by another network node (e.g., a DU and/or RU). In some aspects, the indication may indicate that the cell coverage is about to be changed (e.g., increased or decreased) so that the UE can take it into account whether to stay on the serving cell, or handover to another cell. The indication shown by reference number 430 can be transmitted using RRC signaling, a medium access control control element (MAC-CE), or downlink control information (DCI). The indication shown by reference number 430 can also be implemented in example 500 of FIG. 5, described elsewhere herein.

As shown by reference number 440, the network node (e.g., a CU, a DU, and/or an RU) may transmit, and the UE may receive, an indication of a selected configuration. The indication of the selected configuration can be transmitted using Layer 1 signaling (e.g., DCI), Layer 2 signaling (e.g., a MAC-CE), or a combination thereof (e.g., down-selection from the plurality of configurations via MAC-CE signaling, then selection of one of the down-selected configurations via DCI signaling). In some aspects, the network node (e.g., a CU and/or DU) may provide the indication for transmission by another network node (e.g., a DU and/or RU). In some aspects, the indication may indicate a single selected configuration. In some other aspects, the indication may indicate multiple selected configurations, such as a first configuration pertaining to a first cell and a second configuration pertaining to a second cell, or a first configuration pertaining to a first type of measurement and a second configuration pertaining to a second type of measurement, or a combination thereof. In some aspects, the network node may select the selected configuration. For example, the network node may select the selected configuration based at least in part on the predicted coverage change. More particularly, in the case of a predicted coverage change involving a decrease in coverage, the network node may select a threshold or scaling factor that is likely to trigger an earlier handover (such as due to a dynamic antenna or beam adaptation) than a threshold or scaling factor associated with an increase in coverage.

As shown by reference number 450, the UE may measure reference signals of the serving cell and/or one or more neighbor cells of the UE. In some aspects, the UE may measure the reference signals based at least in part on the selected configuration (e.g., the UE may determine whether a selected value indicated by the selected configuration is satisfied by a metric derived from the measurement and/or may determine whether a threshold indicated by the measurement reporting event is satisfied for a threshold length of time indicated by the selected value). To measure the reference signals, the UE may determine a metric (e.g., an SINR metric, an RSRP metric, an RSRQ metric, or the like) for resources identified by one or more measurement configurations as associated with the reference signals. The reference signals can include any reference signal used for radio resource management (RRM) measurement and/or indicatable by a measurement configuration, such as a CSI-RS, an SSB, or the like. In some aspects, the UE may apply a scaling factor to one or more metrics determined based at least in part on the measurement, as described in more detail in connection with FIG. 5.

As shown by reference number 460, the UE may transmit, and the network node may receive, a measurement report. For example, the UE may transmit, and the network node may receive, one or more measurement reports. In some aspects, the measurement report (or the transmission of the measurement report) may be based at least in part on a selected value corresponding to the configuration selected at reference number 440. For example, the UE may transmit the measurement report based at least in part on a threshold for a metric (as indicated by the selected value) associated with a measurement reporting event being satisfied. As another example, the UE may transmit the measurement report based at least in part on a threshold length of time (as indicated by the selected value) associated with the measurement reporting event being satisfied. The measurement report may indicate a cell for which a reporting criterion of the relevant measurement reporting event is satisfied. For example, the measurement report may identify a neighbor cell for which a metric satisfies a threshold associated with the reporting criterion. In some aspects, a first network node (e.g., an RU) may receive the measurement report, and may provide the measurement report to another network node (e.g., a CU and/or DU). In some aspects, a first network node (e.g., an RU and/or a DU) may receive and process the measurement report, and may provide measurement information to a second network node (e.g., a CU and/or a DU).

Thus, the UE may identify a suitable neighbor cell for a handover based at least in part on the selected configuration. In some aspects, the selected configuration may cause the UE to select a suitable neighbor cell more quickly than when the UE selects a neighbor cell using another configuration. For example, the selected configuration may be associated with a lower threshold for a metric and/or a shorter threshold length of time than the other configuration. In this example, the selected configuration may be used when the network node has identified a change in coverage (at reference number 420) as a decrease in coverage, and the other configuration may be used when no decrease in coverage is identified or when an increase in coverage is identified.

As shown by reference number 470, in some aspects, the UE and the network node may perform a handover to a cell indicated by the measurement report. For example, the network node (or a network entity associated with the network node) may trigger a handover of the UE from a serving cell associated with the network node to a neighbor cell (which can be associated with the network node or another network node). In some aspects, the network node (or a network entity associated with the network node) may reconfigure the neighbor cell to increase coverage of the neighbor cell (such as based at least in part on identifying the coverage change of the serving cell). In some aspects, the network node may perform the dynamic network antenna adaptation or dynamic beam adaptation described with regard to reference number 420 (e.g., after the handover of the UE).

In this way, interruption, latency, and unreliability of communications of the UE are reduced by triggering a handover, such as before coverage of the network node is reduced due to the dynamic antenna or beam adaptation.

As indicated above, FIG. 4 is provided as an example. Other examples may differ from what is described with regard to FIG. 4.

FIG. 5 is a diagram illustrating an example 500 of signaling associated with adjustment of a metric associated with a measurement reporting event, in accordance with the present disclosure. As shown, example 500 includes a UE (e.g., UE 120) and a network node (e.g., network node 110). The network node may provide a serving cell of the UE. In some aspects, the network node may include multiple network nodes, such as a CU and a DU, a CU and an RU, a DU and an RU, or a different combination of network nodes.

As shown in FIG. 5, and by reference number 510, the network node (e.g., a CU and/or a DU) may transmit, and the UE may receive, configuration information. For example, the configuration information may be transmitted via control signaling, such as RRC signaling or the like. The configuration information may include a plurality of configurations. A configuration, of the plurality of configurations, may identify a scaling factor for a metric associated with a measurement reporting event. Thus, the configuration information may include a plurality of scaling factors for a measurement reporting event. The scaling factor may be applied to a metric to determine a scaled metric for determination of whether the measurement reporting event is triggered by the scaled metric.

In some aspects, the configuration information may include a measurement configuration, or multiple measurement configurations, that identify or include the plurality of configurations. The measurement configuration may identify configurations for one or more neighbor measurements to be performed by the UE 120. In some aspects, the one or more neighbor measurements may be associated with respective target carriers, cells, or frequencies. A neighbor measurement may include, for example, an RSRP measurement (e.g., an SS-RSRP measurement), an RSRQ measurement (e.g., an SS-RSRQ measurement), an SINR value (e.g., an SS-SINR measurement), and/or the like.

A measurement configuration is a configuration provided from the network node to the UE to configure the UE to perform measurements, such as NR measurements, inter radio access technology measurements of E-UTRA frequencies, or the like. The measurement configuration may configure the UE to report measurement information based at least in part on measurement resources such as SSBs, CSI-RS resources, CSI-IM resources, or the like. The measurement configuration may include measurement objects, reporting configurations, measurement identities, quantity configurations, measurement gap configurations, or a combination thereof. A measurement object may provide a list of objects on which the UE may perform the measurements for intra-frequency and inter-frequency operations. A reporting configuration may indicate a reporting criterion, a reference signal type, and/or a reporting format for a measurement object. A measurement identity may link a measurement object with a reporting configuration. A quantity configuration may describe filter coefficients for Layer 3 filtering of the measurements. A measurement gap configuration may indicate a gap in which the UE 120 is to perform a measurement. In some aspects, the UE 120 may determine measurement information based at least in part on the one or more measurement configurations and/or may report the measurement information based at least in part on the one or more measurement configurations. In some aspects, the measurement configuration may include information indicating a plurality of scaling factors. In some other aspects, information indicating a plurality of scaling factors may be transmitted separately from the measurement configuration (e.g., and may identify a measurement configuration for which the plurality of scaling factors are to be applied).

The network node may configure a plurality of scaling factors associated with a measurement reporting event (or a respective plurality of scaling factors for each measurement reporting event of a plurality of measurement reporting events). For example, a single reporting configuration may be associated with multiple scaling factors (one of which can be selected as described elsewhere herein), or a measurement configuration may include multiple reporting configurations each associated with a scaling factor.

In some aspects, the plurality of configurations may be common across multiple cells. For example, each neighbor cell of the UE may be associated with the same plurality of configurations, meaning that a scaling factor is selected from the same plurality of values for any neighbor cell. In some aspects, a plurality of configurations may be cell-specific. For example, a first cell may be associated with a first plurality of configurations (from which a scaling factor associated with the first cell can be selected), and a second cell may be associated with a second plurality of configurations (from which a scaling factor associated with the second cell can be selected).

In some aspects, the plurality of configurations may be common across two or more types of measurement. For example, a selected scaling factor may be selected from the same plurality of scaling factors for an SINR metric, an RSRP metric, and an RSRQ metric. In some aspects, the plurality of configurations may be specific to a type of measurement. For example, a selected scaling factor may be selected from a first plurality of configurations for an SINR metric, and from a second plurality of configurations for an RSRP metric.

As shown by reference number 520, the network node (e.g., a CU, a DU, and/or an RU) may identify a coverage change. For example, the network node may identify a predicted coverage change of the serving cell associated with the network node. In some aspects, the network node may identify the predicted coverage change based at least in part on dynamic network antenna adaptation and/or dynamic beam adaptation. For example, the network node may identify that the network node will deactivate one or more antennas, antenna sub-panels, or antenna panels at a future time.

As another example, the network node may identify that the network node will deactivate one or more beams at a future time. Thus, the network node may identify a predicted coverage change that will be caused by the deactivation of the one or more beams, antennas, antenna sub-panels, or antenna panels.

As shown by reference number 530, the network node (e.g., a CU, a DU, and/or an RU) may transmit, and the UE may receive, an indication of a selected configuration. For example, the selected configuration may indicate a selected scaling factor of the plurality of scaling factors. The indication of the selected configuration can be transmitted using Layer 1 signaling (e.g., DCI), Layer 2 signaling (e.g., a MAC-CE), or a combination thereof (e.g., down-selection from the plurality of configurations via MAC-CE signaling, then selection of one of the down-selected configurations via DCI signaling). In some aspects, the network node (e.g., a CU and/or DU) may provide the indication for transmission by another network node (e.g., a DU and/or RU). In some aspects, the indication may indicate a single selected configuration. In some other aspects, the indication may indicate multiple selected configurations, such as a first configuration pertaining to a first cell and a second configuration pertaining to a second cell, or a first configuration pertaining to a first type of measurement and a second configuration pertaining to a second type of measurement, or a combination thereof.

As shown by reference number 540, the UE may measure reference signals of the serving cell and/or one or more neighbor cells of the UE. As further shown, the UE may apply the selected scaling factor to a metric determined based at least in part on a reference signal. In this example, if the scaling factor is 1.25 and the metric is an SINR of 13 dB, the UE may determine a scaled metric of 1.25×13 dB=16.25 dB. In some aspects, the UE may measure the reference signals based at least in part on the selected configuration (e.g., the UE may apply the selected scaling factor to metrics determined based at least in part on the reference signals). To measure the reference signals, the UE may determine a metric (e.g., an SINR metric, an RSRP metric, an RSRQ metric, or the like) for resources identified by one or more measurement configurations as associated with the reference signals. The reference signals can include any reference signal used for RRM measurement and/or indicatable by a measurement configuration, such as a CSI-RS, an SSB, or the like. As mentioned above, in some aspects, the UE may apply a scaling factor based at least in part on which cell transmits a reference signal (e.g., a scaling factor associated with the cell, or whether the cell is a serving cell or a neighbor cell), a type of measurement associated with the reference signal, or a combination thereof. For example, the UE may be configured with multiple scaling factors applying to different cells, and may apply a scaling factor associated with the cell from which the reference signal is received. As another example, the UE may apply a first scaling factor for a serving cell and a second scaling factor for a neighbor cell. As another example, the UE may be configured with multiple scaling factors for different types of measurements, and may apply a scaling factor associated with a type of measurement performed based at least in part on the reference signal.

As shown by reference number 550, the UE may transmit, and the network node may receive, a measurement report. For example, the UE may transmit, and the network node may receive, one or more measurement reports. In some aspects, the measurement report (or the transmission of the measurement report) may be based at least in part on a scaling factor corresponding to the configuration selected at reference number 530. For example, the UE may transmit the measurement report based at least in part on a threshold associated with a measurement reporting event being satisfied by a scaled metric (scaled using the scaling factor corresponding to the selected configuration). The measurement report may indicate a cell for which a reporting criterion of the relevant measurement reporting event is satisfied. For example, the measurement report may identify a neighbor cell for which a metric satisfies a threshold associated with the reporting criterion. In some aspects, a first network node (e.g., an RU) may receive the measurement report, and may provide the measurement report to another network node (e.g., a CU and/or DU). In some aspects, a first network node (e.g., an RU and/or a DU) may receive and process the measurement report, and may provide measurement information to a second network node (e.g., a CU and/or a DU).

Thus, the UE may identify a suitable neighbor cell for a handover based at least in part on the selected configuration. In some aspects, the selected configuration may cause the UE to select a suitable neighbor cell more quickly than when the UE selects a neighbor cell using another configuration. For example, the selected configuration may cause a metric to be adjusted such that handover occurs more quickly or more frequently than a metric adjusted according to the other configuration. In this example, the selected configuration may be used when the network node has identified a change in coverage (at reference number 520) as a decrease in coverage, and the other configuration may be used when no decrease in coverage is identified or when an increase in coverage is identified.

As shown by reference number 560, in some aspects, the UE and the network node may perform a handover to a cell indicated by the measurement report. For example, the network node (or a network entity associated with the network node) may trigger a handover of the UE from a serving cell associated with the network node to a neighbor cell (which can be associated with the network node or another network node). In some aspects, the network node (or a network entity associated with the network node) may reconfigure the neighbor cell to increase coverage of the neighbor cell (such as based at least in part on identifying the coverage change of the serving cell). In some aspects, the network node may perform the dynamic network antenna adaptation or dynamic beam adaptation described with regard to reference number 520 (e.g., after the handover of the UE).

In this way, interruption, latency, and unreliability of communications of the UE are reduced by triggering a handover, such as before coverage of the network node is reduced due to the dynamic antenna or beam adaptation.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with mobility enhancements.

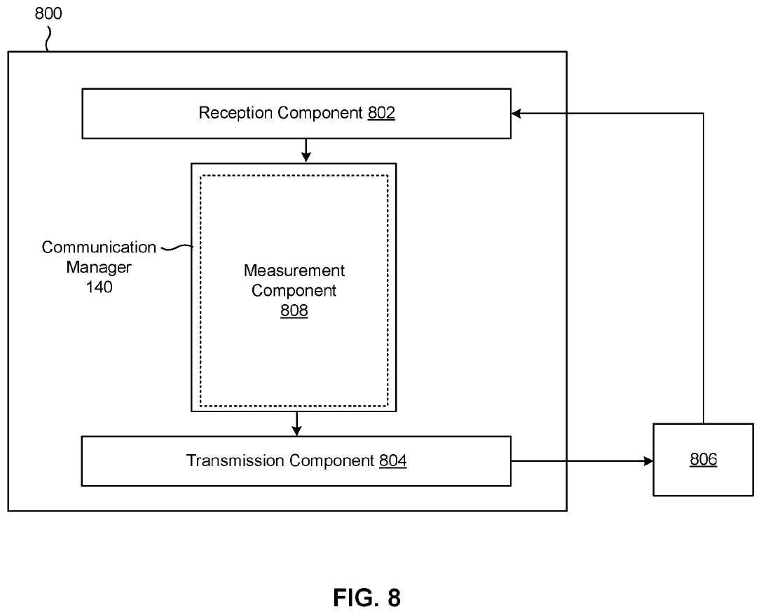

As shown in FIG. 6, in some aspects, process 600 may include receiving configuration information indicating a plurality of configurations, the plurality of configurations indicating at least one of: a plurality of values for a measurement reporting event, or a plurality of scaling factors for a metric associated with the measurement reporting event (block 610). For example, the UE (e.g., using communication manager 140 and/or reception component 802, depicted in FIG. 8) may receive configuration information indicating a plurality of configurations, the plurality of configurations indicating at least one of: a plurality of values for a measurement reporting event, or a plurality of scaling factors for a metric associated with the measurement reporting event, as described above.

As further shown in FIG. 6, in some aspects, process 600 may include receiving an indication of a selected configuration of the plurality of configurations (block 620). For example, the UE (e.g., using communication manager 140 and/or reception component 802, depicted in FIG. 8) may receive an indication of a selected configuration of the plurality of configurations, as described above.

As further shown in FIG. 6, in some aspects, process 600 may include measuring a reference signal based at least in part on the selected configuration (block 630). For example, the UE (e.g., using communication manager 140 and/or measurement component 808, depicted in FIG. 8) may measure a reference signal based at least in part on the selected configuration, as described above.

Process 600 may include additional aspects, such as any single aspect or any combination of aspects described below and/or in connection with one or more other processes described elsewhere herein.

In a first aspect, measuring the reference signal based at least in part on the selected configuration further comprises applying a selected scaling factor, of the plurality of scaling factors, associated with the selected configuration to a metric determined based at least in part on the reference signal.

In a second aspect, alone or in combination with the first aspect, the selected scaling factor is applied for a serving cell of the UE and a neighbor cell of the UE.

In a third aspect, alone or in combination with one or more of the first and second aspects, process 600 includes transmitting (e.g., using communication manager 140 or transmission component 804 of FIG. 8) a measurement report based at least in part on a selected value, of the plurality of values, for the measurement reporting event being satisfied.

In a fourth aspect, alone or in combination with one or more of the first through third aspects, process 600 includes performing a handover to a cell indicated by the measurement report.

In a fifth aspect, alone or in combination with one or more of the first through fourth aspects, a first value of the plurality of values is larger than a second value of the plurality of values.

In a sixth aspect, alone or in combination with one or more of the first through fifth aspects, a first scaling factor of the plurality of scaling factors is larger than a second scaling factor of the plurality of scaling factors.

In a seventh aspect, alone or in combination with one or more of the first through sixth aspects, the plurality of values are common across two or more neighbor cells.

In an eighth aspect, alone or in combination with one or more of the first through seventh aspects, the plurality of scaling factors are common across two or more cells.

In a ninth aspect, alone or in combination with one or more of the first through eighth aspects, the plurality of values are cell-specific.

In a tenth aspect, alone or in combination with one or more of the first through ninth aspects, the plurality of scaling factors are cell-specific.

In an eleventh aspect, alone or in combination with one or more of the first through tenth aspects, the indication is received via downlink control information signaling or medium access control signaling.

In a twelfth aspect, alone or in combination with one or more of the first through eleventh aspects, the plurality of scaling factors are specific to a type of measurement.

In a thirteenth aspect, alone or in combination with one or more of the first through twelfth aspects, the plurality of scaling factors are common across two or more types of measurement.

In a fourteenth aspect, alone or in combination with one or more of the first through thirteenth aspects, the indication is associated with a dynamic network antenna adaptation.

In a fifteenth aspect, alone or in combination with one or more of the first through fourteenth aspects, the indication is associated with a predicted change in coverage of a serving cell of the UE.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 110) performs operations associated with mobility enhancements.

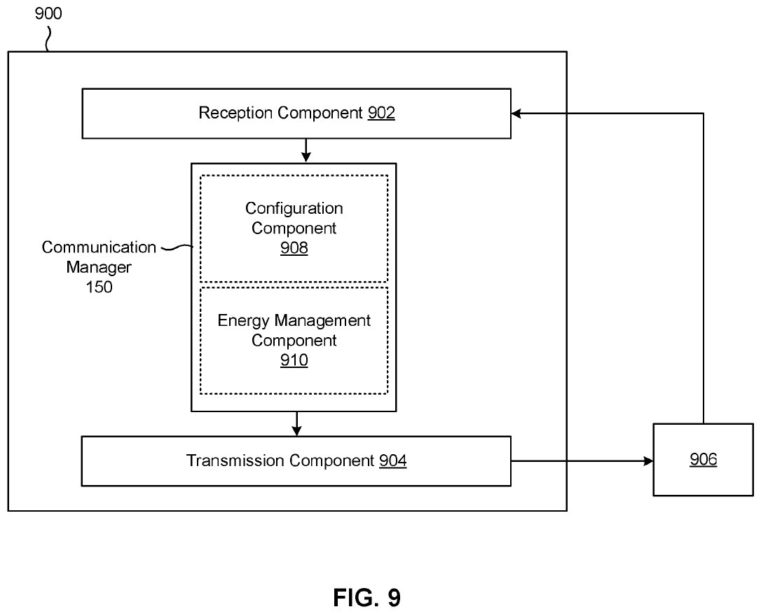

As shown in FIG. 7, in some aspects, process 700 may include transmitting configuration information indicating a plurality of configurations, the plurality of configurations indicating at least one of: a plurality of values for a measurement reporting event, or a plurality of scaling factors for a metric associated with the measurement reporting event (block 710). For example, the network node (e.g., using communication manager 150 and/or configuration component 908, depicted in FIG. 9) may transmit configuration information indicating a plurality of configurations, the plurality of configurations indicating at least one of: a plurality of values for a measurement reporting event, or a plurality of scaling factors for a metric associated with the measurement reporting event, as described above.

As further shown in FIG. 7, in some aspects, process 700 may include transmitting, for a UE, an indication of a selected configuration of the plurality of configurations (block 720). For example, the network node (e.g., using communication manager 150 and/or transmission component 904, depicted in FIG. 9) may transmit, for a UE, an indication of a selected configuration of the plurality of configurations, as described above. In some aspects, a first network node may transmit the configuration information, and a second network node (e.g., associated with the first network node) may transmit the indication of the selected configuration. In some aspects, the network node may provide the indication and/or the configuration information for transmission. In some aspects, the network node may receive the indication and/or the configuration information from another network node, and may transmit the indication and/or the configuration information.

As further shown in FIG. 7, in some aspects, process 700 may include receiving a measurement report associated with the UE based at least in part on the selected configuration (block 730). For example, the network node (e.g., using communication manager 150 and/or reception component 902, depicted in FIG. 9) may receive a measurement report associated with the UE based at least in part on the selected configuration, as described above. In some aspects, the network node may receive a transmission of the measurement report, and may process the measurement report. In some aspects, the network node may receive the measurement report and/or measurement information based at least in part on the measurement report from another network node (e.g., where the other network node received and/or processed the measurement report).

Process 700 may include additional aspects, such as any single aspect or any combination of aspects described below and/or in connection with one or more other processes described elsewhere herein.

In a first aspect, the measurement report is based at least in part on a metric scaled using a selected scaling factor, of the plurality of scaling factors, associated with the selected configuration.

In a second aspect, alone or in combination with the first aspect, the selected scaling factor is associated with a serving cell of the UE and a neighbor cell of the UE.

In a third aspect, alone or in combination with one or more of the first and second aspects, process 700 includes transmitting a measurement report based at least in part on a selected value, of the plurality of values, for the measurement reporting event being satisfied.

In a fourth aspect, alone or in combination with one or more of the first through third aspects, process 700 includes triggering a handover of the UE to a cell indicated by the measurement report.

In a fifth aspect, alone or in combination with one or more of the first through fourth aspects, a first value of the plurality of values is larger than a second value of the plurality of values.

In a sixth aspect, alone or in combination with one or more of the first through fifth aspects, a first scaling factor of the plurality of scaling factors is larger than a second scaling factor of the plurality of scaling factors.

In a seventh aspect, alone or in combination with one or more of the first through sixth aspects, the plurality of values are common across two or more cells.

In an eighth aspect, alone or in combination with one or more of the first through seventh aspects, the plurality of scaling factors are common across two or more cells.

In a ninth aspect, alone or in combination with one or more of the first through eighth aspects, the plurality of values are cell-specific.

In a tenth aspect, alone or in combination with one or more of the first through ninth aspects, the plurality of scaling factors are cell-specific.

In an eleventh aspect, alone or in combination with one or more of the first through tenth aspects, the indication is transmitted via downlink control information signaling or medium access control signaling.

In a twelfth aspect, alone or in combination with one or more of the first through eleventh aspects, the plurality of scaling factors are specific to a type of measurement.

In a thirteenth aspect, alone or in combination with one or more of the first through twelfth aspects, the plurality of scaling factors are common across two or more types of measurement.

In a fourteenth aspect, alone or in combination with one or more of the first through thirteenth aspects, the indication is associated with a dynamic network antenna adaptation.

In a fifteenth aspect, alone or in combination with one or more of the first through fourteenth aspects, the indication is associated with a predicted change in coverage of a cell of the network node.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include a measurement component 808, among other examples.

In some aspects, the apparatus 800 may be configured to perform one or more operations described herein in connection with FIGS. 3-5. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive configuration information indicating a plurality of configurations, the plurality of configurations indicating at least one of a plurality of values for a measurement reporting event, or a plurality of scaling factors for a metric associated with the measurement reporting event. The reception component 802 may receive an indication of a selected configuration of the plurality of configurations. The measurement component 808 may measure a reference signal based at least in part on the selected configuration.

The transmission component 804 may transmit a measurement report based at least in part on a selected value, of the plurality of values, for the measurement reporting event being satisfied.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include a configuration component 908 or an energy management component 910, among other examples.

In some aspects, the apparatus 900 may be configured to perform one or more operations described herein in connection with FIGS. 3-5. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2. In some aspects, the reception component 902 may include an interface that communicates with another network node, such as another network node providing radio functionality (e.g., an RU).

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver. In some aspects, the transmission component 904 may include an interface that communicates with another network node, such as another network node providing radio functionality (e.g., an RU).

The transmission component 904 may transmit configuration information indicating a plurality of configurations, the plurality of configurations indicating at least one of a plurality of values for a measurement reporting event, or a plurality of scaling factors for a metric associated with the measurement reporting event. The transmission component 904 may transmit, for a UE, an indication of a selected configuration of the plurality of configurations. The reception component 902 may receive a measurement report associated with the UE based at least in part on the selected configuration. The energy management component 910 may identify a coverage change, such as based at least in part on dynamic network antenna adaptation or dynamic beam adaptation of the apparatus 900.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

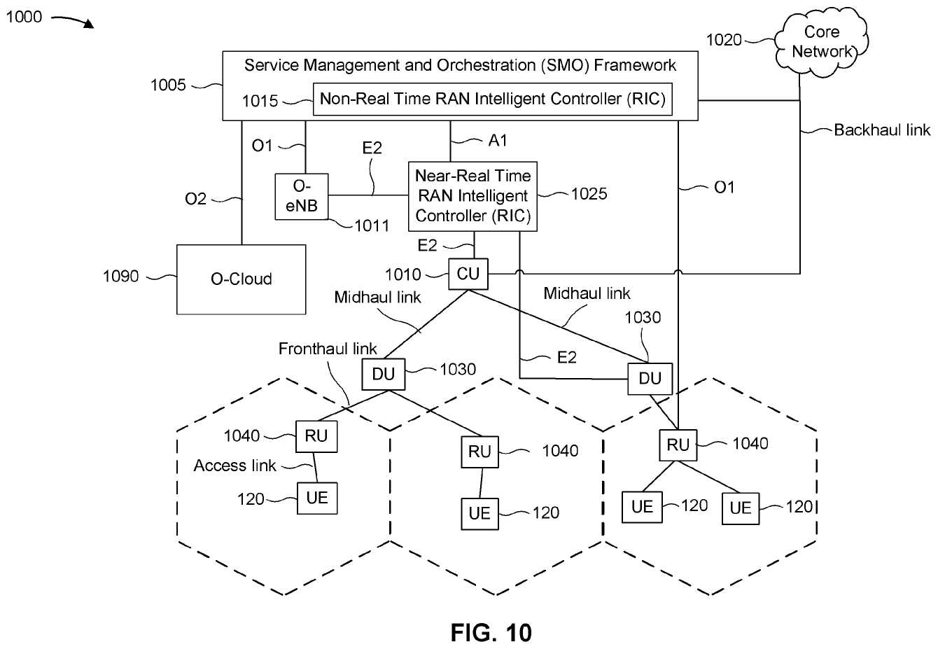

FIG. 10 is a diagram illustrating an example disaggregated base station architecture 1000, in accordance with the present disclosure. The disaggregated base station architecture 1000 may include a CU 1010 that can communicate directly with a core network 1020 via a backhaul link, or indirectly with the core network 1020 through one or more disaggregated control units (such as a Near-RT RIC 1025 via an E2 link, or a Non-RT RIC 1015 associated with a Service Management and Orchestration (SMO) Framework 1005, or both). A CU 1010 may communicate with one or more DUs 1030 via respective midhaul links, such as through F1 interfaces. Each of the DUs 1030 may communicate with one or more RUs 1040 via respective fronthaul links. Each of the RUs 1040 may communicate with one or more UEs 120 via respective radio frequency (RF) access links. In some implementations, a UE 120 may be simultaneously served by multiple RUs 1040.

Each of the units, including the CUs 1010, the DUs 1030, the RUs 1040, as well as the Near-RT RICs 1025, the Non-RT RICs 1015, and the SMO Framework 1005, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 1010 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 1010. The CU 1010 may be configured to handle user plane functionality (for example, Central Unit-User Plane (CU-UP) functionality), control plane functionality (for example, Central Unit-Control Plane (CU-CP) functionality), or a combination thereof. In some implementations, the CU 1010 can be logically split into one or more CU-UP units and one or more CU-CP units. A CU-UP unit can communicate bidirectionally with a CU-CP unit via an interface, such as the E1 interface when implemented in an O-RAN configuration. The CU 1010 can be implemented to communicate with a DU 1030, as necessary, for network control and signaling.

Each DU 1030 may correspond to a logical unit that includes one or more base station functions to control the operation of one or more RUs 1040. In some aspects, the DU 1030 may host one or more of a radio link control (RLC) layer, a MAC layer, and one or more high physical (PHY) layers depending, at least in part, on a functional split, such as a functional split defined by the 10GPP. In some aspects, the one or more high PHY layers may be implemented by one or more modules for forward error correction (FEC) encoding and decoding, scrambling, and modulation and demodulation, among other examples. In some aspects, the DU 1030 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 1030, or with the control functions hosted by the CU 1010.

Each RU 1040 may implement lower-layer functionality. In some deployments, an RU 1040, controlled by a DU 1030, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 10GPP), such as a lower layer functional split. In such an architecture, each RU 1040 can be operated to handle over the air (OTA) communication with one or more UEs 120. In some implementations, real-time and non-real-time aspects of control and user plane communication with the RU(s) 1040 can be controlled by the corresponding DU 1030. In some scenarios, this configuration can enable each DU 1030 and the CU 1010 to be implemented in a cloud-based RAN architecture, such as a vRAN architecture.

The SMO Framework 1005 may be configured to support RAN deployment and provisioning of non-virtualized and virtualized network elements. For non-virtualized network elements, the SMO Framework 1005 may be configured to support the deployment of dedicated physical resources for RAN coverage requirements, which may be managed via an operations and maintenance interface (such as an O1 interface).

For virtualized network elements, the SMO Framework 1005 may be configured to interact with a cloud computing platform (such as an open cloud (O-Cloud) platform 1090) to perform network element life cycle management (such as to instantiate virtualized network elements) via a cloud computing platform interface (such as an O2 interface). Such virtualized network elements can include, but are not limited to, CUs 1010, DUs 1030, RUs 1040, non-RT RICs 1015, and Near-RT RICs 1025. In some implementations, the SMO Framework 1005 can communicate with a hardware aspect of a 4G RAN, such as an open eNB (O-eNB) 1011, via an O1 interface. Additionally, in some implementations, the SMO Framework 1005 can communicate directly with each of one or more RUs 1040 via a respective O1 interface. The SMO Framework 1005 also may include a Non-RT RIC 1015 configured to support functionality of the SMO Framework 1005.

The Non-RT RIC 1015 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1025. The Non-RT RIC 1015 may be coupled to or communicate with (such as via an A1 interface) the Near-RT RIC 1025. The Near-RT RIC 1025 may be configured to include a logical function that enables near-real-time control and optimization of RAN elements and resources via data collection and actions over an interface (such as via an E2 interface) connecting one or more CUs 1010, one or more DUs 1030, or both, as well as an O-eNB, with the Near-RT RIC 1025.

In some implementations, to generate AI/ML models to be deployed in the Near-RT RIC 1025, the Non-RT RIC 1015 may receive parameters or external enrichment information from external servers. Such information may be utilized by the Near-RT RIC 1025 and may be received at the SMO Framework 1005 or the Non-RT RIC 1015 from non-network data sources or from network functions. In some examples, the Non-RT RIC 1015 or the Near-RT RIC 1025 may be configured to tune RAN behavior or performance. For example, the Non-RT RIC 1015 may monitor long-term trends and patterns for performance and employ AI/ML models to perform corrective actions through the SMO Framework 1005 (such as reconfiguration via an O1 interface) or via creation of RAN management policies (such as A1 interface policies).

As indicated above, FIG. 10 is provided as an example. Other examples may differ from what is described with regard to FIG. 10.

The following provides an overview of some Aspects of the present disclosure:

Aspect 1: A method of wireless communication performed by a user equipment (UE), comprising: receiving configuration information indicating a plurality of configurations, the plurality of configurations indicating at least one of: a plurality of values for a measurement reporting event, or a plurality of scaling factors for a metric associated with the measurement reporting event; receiving an indication of a selected configuration of the plurality of configurations; and measuring a reference signal based at least in part on the selected configuration.

Aspect 2: The method of Aspect 1, wherein measuring the reference signal based at least in part on the selected configuration further comprises: applying a selected scaling factor, of the plurality of scaling factors, associated with the selected configuration to a metric determined based at least in part on the reference signal.

Aspect 3: The method of Aspect 2, wherein the selected scaling factor is applied for a serving cell of the UE and a neighbor cell of the UE.

Aspect 4: The method of any of Aspects 1-3, further comprising: transmitting a measurement report based at least in part on a selected value, of the plurality of values, for the measurement reporting event being satisfied.

Aspect 5: The method of Aspect 4, further comprising: performing a handover to a cell indicated by the measurement report.

Aspect 6: The method of any of Aspects 1-5, wherein a first value of the plurality of values is larger than a second value of the plurality of values.

Aspect 7: The method of any of Aspects 1-6, wherein a first scaling factor of the plurality of scaling factors is larger than a second scaling factor of the plurality of scaling factors.

Aspect 8: The method of any of Aspects 1-7, wherein the plurality of values are common across two or more neighbor cells.

Aspect 9: The method of any of Aspects 1-8, wherein the plurality of scaling factors are common across two or more cells.

Aspect 10: The method of any of Aspects 1-7 or 9, wherein the plurality of values are cell-specific.

Aspect 11: The method of any of Aspects 1-8 or 10, wherein the plurality of scaling factors are cell-specific.

Aspect 12: The method of any of Aspects 1-11, wherein the indication is received via downlink control information signaling or medium access control signaling.

Aspect 13: The method of any of Aspects 1-12, wherein the plurality of scaling factors are specific to a type of measurement.

Aspect 14: The method of any of Aspects 1-12, wherein the plurality of scaling factors are common across two or more types of measurement.

Aspect 15: The method of any of Aspects 1-14, wherein the indication is associated with a dynamic network antenna adaptation.

Aspect 16: The method of any of Aspects 1-15, wherein the indication is associated with a predicted change in coverage of a serving cell of the UE.

Aspect 17: A method of wireless communication performed by a network node, comprising: transmitting configuration information indicating a plurality of configurations, the plurality of configurations indicating at least one of: a plurality of values for a measurement reporting event, or a plurality of scaling factors for a metric associated with the measurement reporting event; transmitting, for a user equipment (UE), an indication of a selected configuration of the plurality of configurations; and receiving a measurement report associated with the UE based at least in part on the selected configuration.

Aspect 18: The method of Aspect 17, wherein the measurement report is based at least in part on a metric scaled using a selected scaling factor, of the plurality of scaling factors, associated with the selected configuration.

Aspect 19: The method of Aspect 18, wherein the selected scaling factor is associated with a serving cell of the UE and a neighbor cell of the UE.

Aspect 20: The method of any of Aspects 17-19, wherein receiving the measurement report further comprises: receiving a measurement report based at least in part on a selected value, of the plurality of values, for the measurement reporting event being satisfied.

Aspect 21: The method of Aspect 20, further comprising: triggering a handover of the UE to a cell indicated by the measurement report.

Aspect 22: The method of any of Aspects 17-21, wherein a first value of the plurality of values is larger than a second value of the plurality of values.

Aspect 23: The method of any of Aspects 17-22, wherein a first scaling factor of the plurality of scaling factors is larger than a second scaling factor of the plurality of scaling factors.

Aspect 24: The method of any of Aspects 17-23, wherein the plurality of values are common across two or more cells.

Aspect 25: The method of any of Aspects 17-24, wherein the plurality of scaling factors are common across two or more cells.

Aspect 26: The method of any of Aspects 17-23 or 25, wherein the plurality of values are cell-specific.

Aspect 27: The method of any of Aspects 17-24 or 26, wherein the plurality of scaling factors are cell-specific.

Aspect 28: The method of any of Aspects 17-27, wherein the indication is transmitted via downlink control information signaling or medium access control signaling.

Aspect 29: The method of any of Aspects 17-28, wherein the plurality of scaling factors are specific to a type of measurement.

Aspect 30: The method of any of Aspects 17-28, wherein the plurality of scaling factors are common across two or more types of measurement.

Aspect 31: The method of any of Aspects 17-30, wherein the indication is associated with a dynamic network antenna adaptation.

Aspect 32: The method of any of Aspects 17-30, wherein the indication is associated with a predicted change in coverage of a cell of the network node.

Aspect 33: An apparatus for wireless communication at a device, comprising a processor; memory coupled with the processor; and instructions stored in the memory and executable by the processor to cause the apparatus to perform the method of one or more of Aspects 1-32.

Aspect 34: A device for wireless communication, comprising a memory and one or more processors coupled to the memory, the one or more processors configured to perform the method of one or more of Aspects 1-32.

Aspect 35: An apparatus for wireless communication, comprising at least one means for performing the method of one or more of Aspects 1-32.

Aspect 36: A non-transitory computer-readable medium storing code for wireless communication, the code comprising instructions executable by a processor to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive configuration information indicating a plurality of configurations, the plurality of configurations indicating at least one of:
a plurality of values for a measurement reporting event, or
a plurality of scaling factors for a metric associated with the measurement reporting event;
receive an indication of a selected configuration of the plurality of configurations; and
measure a reference signal based at least in part on the selected configuration.

2. The UE of claim 1, wherein the one or more processors, to measure the reference signal based at least in part on the selected configuration, are configured to:
apply a selected scaling factor, of the plurality of scaling factors, associated with the selected configuration to a metric determined based at least in part on the reference signal.

3. The UE of claim 2, wherein the selected scaling factor is applied for a serving cell of the UE and a neighbor cell of the UE.

4. The UE of claim 1, wherein the one or more processors are further configured to:
transmit a measurement report based at least in part on a selected value, of the plurality of values, for the measurement reporting event being satisfied.

5. The UE of claim 4, wherein the one or more processors are further configured to:
perform a handover to a cell indicated by the measurement report.

6. The UE of claim 1, wherein a first value of the plurality of values is larger than a second value of the plurality of values.

7. The UE of claim 1, wherein a first scaling factor of the plurality of scaling factors is larger than a second scaling factor of the plurality of scaling factors.

8. The UE of claim 1, wherein the plurality of values are common across two or more cells.

9. The UE of claim 1, wherein the plurality of scaling factors are common across two or more cells.

10. The UE of claim 1, wherein the plurality of values are cell-specific.

11. The UE of claim 1, wherein the plurality of scaling factors are cell-specific.

12. The UE of claim 1, wherein the indication is received via downlink control information signaling or medium access control signaling.

13. The UE of claim 1, wherein the plurality of scaling factors are specific to a type of measurement.

14. The UE of claim 1, wherein the plurality of scaling factors are common across two or more types of measurement.

15. The UE of claim 1, wherein the indication is associated with a dynamic network antenna adaptation of a network node transmitting the configuration information.

16. The UE of claim 1, wherein the indication is associated with a predicted change in coverage of a serving cell of the UE.

17. A network node for wireless communication, comprising:
a memory; and
one or more processors, coupled to the memory, configured to:
transmit configuration information indicating a plurality of configurations, the plurality of configurations indicating at least one of:
a plurality of values for a measurement reporting event, or
a plurality of scaling factors for a metric associated with the measurement reporting event;
transmit, for a user equipment (UE), an indication of a selected configuration of the plurality of configurations; and
receive a measurement report associated with the UE based at least in part on the selected configuration.

18. The network node of claim 17, wherein the measurement report is based at least in part on a metric scaled using a selected scaling factor, of the plurality of scaling factors, associated with the selected configuration.

19. The network node of claim 18, wherein the selected scaling factor is associated with a serving cell of the UE and a neighbor cell of the UE.

20. The network node of claim 17, wherein the one or more processors, to receive the measurement report, are configured to:
receive a measurement report based at least in part on a selected value, of the plurality of values, for the measurement reporting event being satisfied.

21. The network node of claim 17, wherein the one or more processors are further configured to:
trigger a handover of the UE to a cell indicated by the measurement report.

22. The network node of claim 17, wherein the indication is associated with a dynamic network antenna adaptation of the network node.

23. The network node of claim 17, wherein the indication is associated with a predicted change in coverage of a cell of the network node.

24. A method of wireless communication performed by a user equipment (UE), comprising:
receiving configuration information indicating a plurality of configurations, the plurality of configurations indicating at least one of:
a plurality of values for a measurement reporting event, or
a plurality of scaling factors for a metric associated with the measurement reporting event;
receiving an indication of a selected configuration of the plurality of configurations; and
measuring a reference signal based at least in part on the selected configuration.

25. The method of claim 24, wherein measuring the reference signal based at least in part on the selected configuration further comprises:
applying a selected scaling factor, of the plurality of scaling factors, associated with the selected configuration to a metric determined based at least in part on the reference signal.

26. The method of claim 25, wherein the selected scaling factor is applied for a serving cell of the UE and a neighbor cell of the UE.

27. The method of claim 24, further comprising:
transmitting a measurement report based at least in part on a selected value, of the plurality of values, for the measurement reporting event being satisfied.

28. A method of wireless communication performed by a network node, comprising:
transmitting configuration information indicating a plurality of configurations, the plurality of configurations indicating at least one of:
a plurality of values for a measurement reporting event, or
a plurality of scaling factors for a metric associated with the measurement reporting event;
transmitting, for a user equipment (UE), an indication of a selected configuration of the plurality of configurations; and
receiving a measurement report associated with the UE based at least in part on the selected configuration.

29. The method of claim 28, wherein the measurement report is based at least in part on a metric scaled using a selected scaling factor, of the plurality of scaling factors, associated with the selected configuration.

30. The method of claim 29, wherein the selected scaling factor is associated with a serving cell of the UE and a neighbor cell of the UE.
